(19) United States
(12) Patent Application Publication
(10) Pub. No.: US 2024/0017344 A1
(43) Pub. Date: Jan. 18, 2024

(54) TORCH NECK FOR THERMALLY JOINING AT LEAST ONE WORKPIECE, TORCH WITH TORCH NECK, AND WELDING DEVICE

(71) Applicant: Alexander Binzel Schweisstechnik GmbH & Co. KG, Buseck (DE)

(72) Inventors: Sascha Rose, Fernwald (DE); Matthias Bickelhaupt, Wellenberg (DE)

(73) Assignee: Alexander Binzel Schweisstechnik GmbH & Co. KG, Buseck (DE)

(21) Appl. No.: 18/254,920

(22) PCT Filed: Dec. 1, 2021
(86) PCT No.: PCT/EP2021/083724

§ 371 Date: May 30, 2023

(30) Foreign Application Priority Data
Dec. 9, 2020 (DE) 10 2020 132 821.4

(51) Int. Cl. B23K 9/29

(52) U.S. Cl. CPC B23K 9/291

(57) ABSTRACT

A nozzle stock (3) for a torch neck (10) of a welding device has an internal cavity (7) and at least one gas-outlet opening (8), which is in fluidic connection with the gas outlet (2) of a gas nozzle (1). A nozzle-stock insert (20) in the internal cavity (7) of the nozzle stock (3) has a front end (23) and a rear end (24), wherein the outer wall (22) of the nozzle-stock insert (20) is at a distance from the inner wall (9) of the nozzle stock (3), at least in some regions, to form a flow space (11) that is in fluidic connection with the gas-outlet opening (8) of the nozzle stock (3). A front and/or rear inflow region, which is formed by a front and/or rear gap (25, 26), is provided at the front end (23) and/or at the rear end (24) of the nozzle-stock insert (20).

### CROSS-REFERENCE TO RELATED APPLICATIONS

This application is a national stage application (under 35 USC §371) of PCT/EP2021/083724, filed Dec. 1, 2021, which claims benefit of DE 102020132821.4, filed Dec. 9, 2020, the contents of each of which is incorporated by reference herein.

### BACKGROUND OF THE INVENTION

### Technical Field and State of the Art

The invention relates to a torch neck for thermally joining at least one workpiece and to a torch with such a torch neck and a welding apparatus.

Thermal joining methods use energy to melt and join workpieces. “MIG”, “MAG”, and “WIG” welding is routinely used for sheet metal fabrication.

On inert gas-supported arc welding methods with melting electrode (MSG), “MIG” is short for “Metal Inert Gas”, and “MAG” is short for “Metal Active Gas”. On inert gas-supported arc welding methods with non-melting electrode (TIG), “TIG” is short for “Tungsten Inert Gas”. The inventive welding apparatuses can be adapted as machine-guided torches that are arranged on a robot arm. But manually guided torches are also conceivable.

To melt the weld metal, arc welding apparatuses generally generate an arc between the workpiece and a melting or non-melting welding electrode. The weld metal and the welding location are shielded by a stream of protective gas against ambient gases.

The welding electrode is in this case provided on a torch body of a welding torch that is connected to an arc welding unit. The torch body typically accommodates a group of interior welding current guiding components that guide the welding current from a welding current source in the arc welding unit to the tip of the torch head onto the welding electrode, in order to then generate the arc from there to the workpiece.

The stream of protective gas flows around the welding electrode, the arc, the weld puddle, and the heat-affected zone on the workpiece, and is then fed to these regions by the torch body of the torch. A gas nozzle guides the stream of protective gas to the front end of the torch head, where the stream of protective gas exits from the torch head approximately annularly about the welding electrode.

During the welding operation, the arc generated for welding heats up the workpiece to be welded and the fed weld metal, if any, such that these are melted.

In addition to welding, brazing is yet another alternative to join sheet metal components. Other than for welding, brazing does not involve melting the workpiece, but only the filler material. The reason for this is that brazing joins two edges with the weld metal as the filler material. The melting temperatures of the weld metal and the component materials lie far part, which is why only the weld metal melts during the operation. In addition to TIG, Plasma, and MIG torches, LASERS are also suited for brazing.

An inventive torch neck or torch can be inserted into such a welding apparatus. Such devices with welding wire and process gas feeder are already known in a variety of ways.

These generally have a wire feed nozzle with a welding wire channel, wherein the wire feed nozzle is detachably connected to a nozzle stock. The nozzle stock in turn is detachably connected to a profile that is equipped with a welding wire channel and connected to a welding wire feed device.

The nozzle stock acts as a connecting element between the current nozzle and the inner tube of the torch, mechanically secures the current nozzle, and guides the electrical current to the front in wire feed direction toward the current nozzle or the arc. Additionally, the nozzle stock guides the protective or process gas through several bores from the interior of the inner tube outward toward the protective gas nozzle, and therefore subsequently lastly toward the welding process. Additionally, the nozzle stock guides thermal energy from the flow nozzle into the rear region of the torch or torch tube.

Whereas the process heat is on water-cooled torches evacuated by cooling water in multi-part tubes, the thermal capacity of the inner tube and also the thermal capacity of the protective gas can be used on air-cooled torches.

Such devices also have a process gas feed device that generally has at least one process gas channel, wherein this process gas feed device is connected to a process gas reservoir. On known devices, the process gas feed device is equipped with a gas nozzle arranged on a nozzle stock, such that process gas exits directly through the nozzle stock. The process gas is substantially intended to blow away the weld smoke generated during welding. When an inert gas is used as the process gas, the process gas also forms a protective gas barrier, therefore allowing very good welding results to be achieved.

A welding apparatus with a gooseneck, a diffuser sleeve, and insert, a flow contact nozzle, and a nozzle is known from WO 2015/148656 A1. These components are commonly connected to each other such that they share a common axis.

The insert has an interior passageway and a wall that extends between the ends of the insert. This wall has at least one hole for a fluidic connection with the interior passageway. The diffuser sleeve has an internal cavity and a wall that extends between the ends. This wall can at least have one hole for the fluidic connection to the internal cavity.

The insert is located in the internal cavity of the diffuser sleeve that is arranged between the gooseneck and the flow contact nozzle. The wall of the insert and the wall of the diffuser sleeve are axially adjacent along the length axis of the end arrangement, and are positioned at a distance from one another in a direction that substantially extends vertically to the length axis of the end arrangement, such that a chamber is formed between the wall of the insert in the wall of the diffuser sleeve. The hole in the wall of the diffuser sleeve and the hole in the wall of the insert have a fluidic connection to the chamber.

Such welding apparatuses are also known from EP 3 112 072 A1 and U.S. Pat. No. 9,950,386 B2.

A disadvantage for these welding apparatuses is the elaborate construction requiring the accurate fit of two hemispherical shells in a heat-affected zone between the flow contact nozzle and the diffuser sleeve. On such known welding apparatuses, the insert is directly connected to the current nozzle, and is therefore exposed to high temperatures, which causes expansion. In particular, the hemispherical adaptation of the rear end of the flow contact nozzle as a wear part is sub-optimal for cost reasons. A further disadvantage is that the connection to the chamber has a propensity to build up dirt because the holes are more readily clogged than for example a gap or an annular gap. Moreover, the holes cause very strong acceleration of the protective gas flow, resulting in turbulences that cannot be dissipated up to the process zone; said turbulences therefore allow ambient oxygen ingress that can negatively impact the protective gas barrier. The holes additionally cause a higher pressure drop and therefore either a reduced protective gas volume or a higher boost pressure to achieve the same protective gas volume.

Further, U.S. Pat. No. 5,313,046 discloses a device for guiding weld wire and process gas of a welding apparatus, which however cannot ensure a satisfactory uniform feeding of the process gas, because the arrangement of the bores guiding the process gas in said device renders nonuniformities unavoidable.

A further disadvantage is on known torches and/or welding apparatuses is that the process heat cannot—or not optimally—be captured and evacuated.

It is therefore an objective of the invention to provide a torch neck and/or a torch and a welding apparatus that facilitates uniform feeding of the process gas about the welding wire onto the welding location or the welding zone, respectively.

A further objective of the invention is to make optimal use of the protective gas to capture and evacuate process heat.

### SUMMARY OF THE INVENTION

The inventive torch neck for thermally joining at least one workpiece, in particular for arc joining, preferably for arc welding or arc soldering, has an electrode or a wire arranged in the torch neck to generate an arc between the electrode or the wire and the workpiece.

Moreover, a gas nozzle for the outflow of a stream of protective gas from a gas outlet of the gas nozzle is provided, having a nozzle stock with an internal cavity and at least one gas outlet opening that has a fluidic connection to the gas outlet of the gas nozzle, and having a nozzle stock insert, with a front end and a rear end that is arranged in the internal cavity of the nozzle stock.

In order to form a flow space for the stream of protective gas, the outer wall of the nozzle stock insert is at least regionally spaced at a distance from the inner wall of the nozzle stock.

The flow space has a fluidic connection to the gas outlet opening of the nozzle stock.

The nozzle stock, the nozzle stock insert, and the gas nozzle are connected to one another such that they share a common axis. The nozzle stock and the gas nozzle can be detachably connected to one another.

The nozzle stocking insert can in this case be located in the nozzle stock. Both parts are then connected to one another by the nozzle stock.

The invention specifies that a front and/or rear inflow region to introduce the protective gas into the flow space is provided on the front end and/or on the rear end of the nozzle stock insert that is formed by a front and/or rear gap.

The gas flow is guided to the nozzle stock insert by an inner tube of the torch neck that has a fluidic connection to a gas reservoir. There, the gas flow can flow in through the inflow region formed by the front gap, and can be guided further into the flow space up to the gas outlet opening of the nozzle stock. Lastly, the gas flow exits from the gas outlet of the gas nozzle to the welding process.

In particular, the protective gas can be introduced through the front inflow region transversally, preferably approximately vertically in relation to the length axis of the nozzle stock into the flow space, through which the protective gas then flows opposite to the flow direction in the interior of the nozzle stock insert, that is to say toward the rear, until the gas is guided through the gas outlet opening of the nozzle stock back to the front toward the gas outlet of the gas nozzle.

The invention specifies that it is alternatively or additionally also conceivable that the inflow region is formed by the rear gap. Said rear gap can be located upstream of the gas outlet opening of the nozzle stock, as seen in flow direction of the protective gas. A linear gas flow is generated in this matter, since the protective gas flows from the inner tube of the torch neck into the inflow region formed by the rear gap, and is introduced into the flow space and then guided through the gas outlet opening of the nozzle stock and then exits from gas outlet of the gas nozzle.

A front and/or rear inflow region is formed to generate turbulent flows of the stream of protective gas that increase the thermal transfer between solid bodies and the protective gas.

A turbulent flow is in particular generated on the inner wall of the nozzle stock. The reduced cross-sections or cross-section changes are associated with high flow speeds or flow speed changes.

The nozzle stock insert is inserted into the opening of the nozzle stock, which can form a gap between its outer wall and the inner wall of the nozzle stock, and, when installed, the gap is either spaced at a distance to the front dead stop of the nozzle stock opening and/or to the attached inner tube, e.g., toward the rear. The gap can either be formed over the entire circumference, e.g., about 360°, or only partially. The protective or process gas can flow through the formed gap toward the borders of the nozzle stock.

The torch neck can preferably be used on air-cooled torch systems. However, the scope of the invention also supports use on water-cooled torch systems.

In this manner, the flow space is merely formed by the arrangement of the nozzle stock insert relative to the nozzle stock. No additional design elements need to be executed on the nozzle stock insert itself, such as passageway holes or the like.

This achieves that the process gas can be uniformly distributed about the nozzle stock already before the outflow onto the gas nozzle or the wire feed nozzle, and does not exit from the nozzle stock only immediately upstream of the gas nozzle. This ensures the uniformity of the process gas about the weld wire in the region of the welding location or the welding zone.

Moreover, the propensity to collect dirt is reduced compared to the inserts with holes or bores known from the prior art, which are easily clogged, and on which the local acceleration of the protective gas flow is less pronounced.

According to a first advantageous embodiment of the invention, the

front end of the nozzle stock insert is spaced at a distance to the front end of the gas outlet opening of the nozzle stock to form the front inflow region formed by the front gap.

According to a further advantageous embodiment of the invention, the rear end of the nozzle stock insert is spaced at a distance to the front end of the inner tube of the torch neck to form the inflow region formed by the rear gap.

These further embodiments achieve a diffuse, e.g., turbulent, flow to increase the thermal transfer between solid bodies and the protective gas.

A passageway recess or a hole—as in the prior art—is by contrast not required on the inventive torch neck. This significantly reduces the design effort.

A further advantageous embodiment of the invention specifies that the outer wall of the nozzle stock insert is at least regionally spaced at a distance from the inner wall of the nozzle stock, such that a flow space can be readily formed.

The protective and/or process gas flow is introduced through the front and/or rear inflow region into the flow space, which is formed with simple design means by the spacing between the nozzle stock and the nozzle stock insert. The gas flows out through the gas outlet opening of the nozzle stock toward the gas outlet of the gas nozzle.

According to an advantageous variant, the rear gap—as seen in flow direction of the protective gas—is located upstream of the gas outlet opening of the nozzle stock to form a linear gas flow.

On this embodiment, on which the inflow region is formed by the rear gap, this gap is located upstream of the gas outlet opening of the nozzle stock, as seen in flow direction of the protective gas. A linear gas flow is generated in this matter, since the protective gas flows from the inner tube of the torch neck into the inflow region formed by the rear gap, and is introduced into the flow space and then guided through the gas outlet opening of the nozzle stock and then exits from gas outlet of the gas nozzle.

The linear gas flow is also called forward flow.

According to a further embodiment, the front gap is located downstream—as seen in flow direction—of the gas outlet opening of the nozzle stock to form a reverse flow of the stream of protective gas.

Alternatively, it is conceivable that the front gap is located downstream—as seen in flow direction—of the gas outlet opening of the nozzle stock such that a reverse flow of the stream of protective gas is formed, since the gas flow is introduced through the inner tube into the interior of the nozzle stock insert, then enters the inflow region formed by the front gap, and is then forwarded into the flow space up to the gas outlet opening of the nozzle stock, through which the gas flow is then guided up to the gas outlet of the gas nozzle.

In this manner, the process or protective gas is not already unnecessarily heated during the welding operation prior to impacting the welding location or the welding zone by the gas or wire feed nozzle, which is at a high temperature. This minimizes the thermally induced flows of the gas, such that the gas can be guided particularly uniformly to the welding location or the welding zone. It has been shown that very good results can as a result be achieved with regard to the weld seam.

The linear, e.g., forward flow, and the reverse flow can also be combined with one another.

On this variant with front gap, it is possible to bring the nozzle stock insert directly into contact with the inner tube, which has the advantage that the inner tube likewise evacuates or distributes heat from front to back into the torch.

In a particularly advantageous manner, the protective gas flows along the outer surface of the nozzle stock insert and/or in the interior of the nozzle stock insert.

According to a further embodiment of the invention, the nozzle stock insert is connected to the nozzle stock, in particular pressed in, such that the insert can be particularly easily assembled.

It can be specified that the flow space for the protective gas is a linear gap between the inner wall of the nozzle stock and the outer wall of the nozzle stock insert substantially extending at least in length direction of the nozzle stock insert.

The gas in this case flows through the rear inflow region formed by the rear gap over the surface of the nozzle stock insert, which has at least one linear gap. The gas is then guided through the gas outlet opening of the nozzle stock toward the gas outlet of the gas nozzle.

The linear gap is easily produced with known manufacturing methods, for example by using standardized profiles. According to the invention, the exterior shape of the profile can have a round or angular cross-section.

A further advantageous embodiment of the invention specifies that the linear gap is formed by the grooves substantially extending in length direction of the nozzle stock insert on the outer wall of the nozzle stock insert, the grooves preferably being arranged approximately equidistantly in relation to one another along the circumference.

The pass-through bores known from the prior art in the wall or in the insert are more elaborately produced compared to a groove specified on the surface. The bores are positioned relative to the bores of the gas nozzle carrier and can deviate in their orientation. In other words, two sleeves or tube bodies slide into one another. Both have a certain number of bores that are distributed along the circumference annularly or lengthwise. But this does not ensure that the bores of the inner sleeve, or the insert, are vertically aligned in relation to the bores of the outer sleeve, e.g., the gas nozzle carrier.

According to an alternative embodiment of the invention, the flow space is substantially formed by a helical gap that is formed by a thread, in particular a trapezoidal thread substantially extending in length direction on the outer wall of the nozzle stock insert. In this manner, the flow channel—and therefore the flow path and the flow time—of the stream of protective gas is significantly lengthened, which in turn leads to an improved thermal absorption and thermal transfer.

Likewise, unintended turbulences of the protective or process gas are further avoided, which would have a negative impact in the welding zone.

A longer path of the gas about the insert or in the nozzle stock is realized than is the case for a linear gas flow path. The thread flanks also cause the gas to flow over a larger total surface area.

According to a further variant of the invention, the nozzle stock insert

has opposing first and second ends that extend along the axis of the nozzle stock insert with a length between the ends, and wherein the diameter of the nozzle stock insert varies along its length.

The nozzle stock insert advantageously has on its front end facing the gas outlet of the gas nozzle a smaller cross-section compared to the rear end of the nozzle stock insert facing away from the gas outlet to form an annular channel of the flow space. The continuity of the uniformity of the protective or process gas on the welding location or the welding zone is likewise ensured in this respect.

According to an advantageous further embodiment of the invention, the flow direction of the stream of protective gas in the annular channel is changed at least once, such that the total flow duration or the flow path of the stream of protective gas is lengthened within the gas nozzle. This adaptation once again improves the thermal absorption and thermal transfer.

According to a further advantageous embodiment of the invention, the nozzle stock insert has an inner passageway to pass through an electrode or a wire to generate an arc between the electrode or the wire and the workpiece.

According to a further embodiment of the invention, the gas flow flows from an inner tube of the torch neck into the nozzle stock insert.

According to an advantageous further embodiment of the invention, a flow contact nozzle is positioned in the internal cavity of the nozzle stock such that it extends into the internal cavity of the nozzle stock, and preferably extends in a direction from the nozzle stock outward in relation to the nozzle stock insert.

It is conceivable that the nozzle stock insert and the flow contact nozzle are not in direct contact to one another, but are instead connected by the nozzle stock. But it is also conceivable that the nozzle stock insert and the flow contact nozzle can contact one another after assembly in the torch, e.g., directly abut one another. The nozzle stock insert is located in the nozzle stock, and the nozzle stock is fastened on the torch.

An advantageous embodiment of the invention specifies that the nozzles stock insert, the flow contact nozzle, and the nozzle stock are made of a conductive material, and that the nozzle stock insert contacts the flow contact nozzle. The conductive material can be copper or copper alloys, for example brass.

An independent thought of the invention specifies a torch with a previously described torch neck.

In a first advantageous embodiment of the torch, the nozzle stock insert is axially arranged in a cavity of the nozzle stock between the torch neck and the flow contact nozzle.

Further objectives, advantages, features, and applications of the present invention are derived from the subsequent description of an embodiment by way of the drawings. All described and/or depicted features per se or in any combination constitute the subject matter of the present invention, regardless of their summary in the patent claims or their back-reference.

### DESCRIPTION OF THE DRAWINGS

Partially schematically, the drawings show in:

FIG. 1 a cross-sectional representation of a cutout of a torch neck with gas nozzle, nozzle stock, nozzle stock insert, according to a first embodiment,

FIG. 2 a detailed side view of the torch neck according to FIG. 1,

FIG. 3 a cross-sectional representation of a cutout of the torch neck with gas nozzle, nozzle stock, nozzle stock insert, according to a second embodiment,

FIG. 4 a cutout of a torch neck with gas nozzle, nozzle stock, nozzle stock insert, according to a third embodiment,

FIG. 5 a perspective side view of the nozzle stock insert with a linear gap,

FIG. 6 an exploded representation of the torch neck, and

FIG. 7 a further exploded representation of the torch neck.

Identical or identically functioning components are provided with reference numerals based on an embodiment in the subsequently depicted figures of the illustration in order to improve readability.

### DETAILED DESCRIPTION

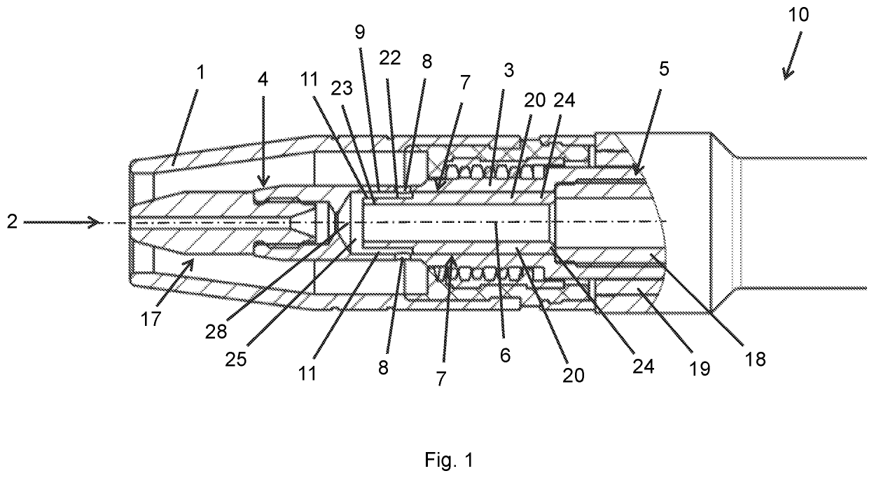

FIG. 1 shows a torch neck 10 for thermally joining at least one workpiece, in particular for arc joining, preferably for arc welding or arc soldering. The torch neck 10 can be part of a torch of a welding apparatus.

See, e.g., US 2021/0078115A1, the contents of which are incorporated herein, showing a torch and torch body of a welding apparatus for thermal joining.

An electrode or a wire for generating an arc between the electrode or the wire and the workpiece is arranged in the torch neck 10.

A gas nozzle 1 is specified for the outflow of a stream of protective gas from a gas outlet 2 of the gas nozzle 1.

A nozzle stock 3 holding the gas nozzle 1 has at least one gas outlet opening 8 for the protective gas, the gas outlet opening 8 having a fluidic connection to the gas outlet 2 of the gas nozzle 1.

The opposing first 4 and second ends 5 of the nozzle stock 3 extend along the axis of the nozzle stock with a length between the ends 4, 5.

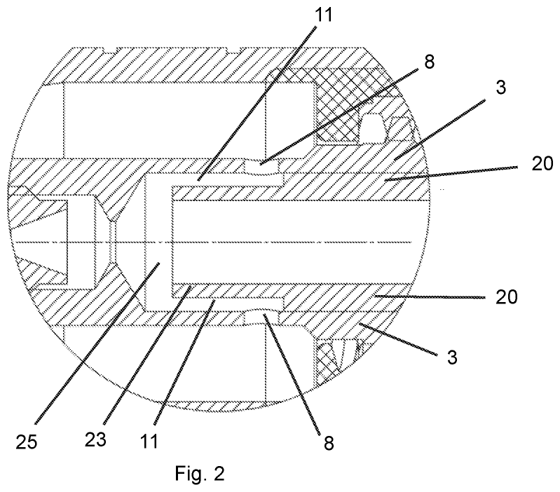

Furthermore, an internal cavity 7 is specified in the nozzle stock 3, in which a nozzle stock insert 20 is arranged with a front end 23 and a rear end 24, as can also be seen in FIG. 1 and also in FIGS. 2 to 4.

The nozzle stock insert 20 is mechanically connected to the nozzle stock 3, in particular is pressed into the latter. The nozzle stock insert 20 has an inner passageway 21 to pass through an electrode or a wire to generate an arc between the electrode or the wire and the workpiece.

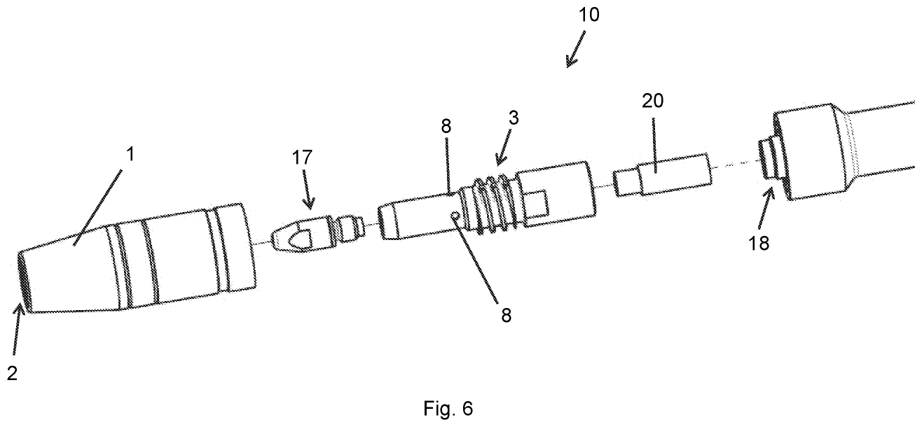

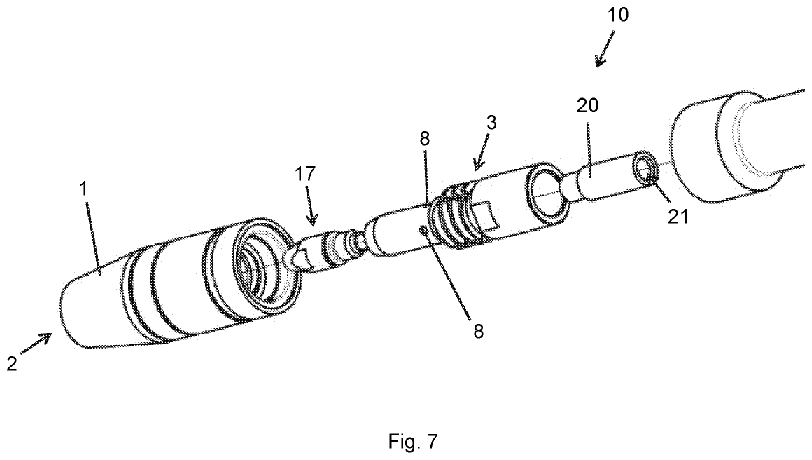

A flow contact nozzle 17 is positioned in the internal cavity 7 of the nozzle stock 3 such that it extends into the internal cavity 7 of the nozzle stock 3, and preferably extends in a direction from the nozzle stock 3 outward in relation to the nozzle stock insert 20, as is in particular also shown in FIGS. 6 and 7 in an exploded representation.

The nozzle stock 3, the nozzle stock insert 20, and the gas nozzle 1 are connected to one another such that they share a common axis, as is shown in FIGS. 1 to 7.

As can likewise be seen in FIGS. 1 to 5, the outer wall 22 of the nozzle stock insert 20 is at least regionally spaced at a distance from the inner wall 9 of the nozzle stock 3 to form a flow space 11 for the stream of protective gas. This flow space 11 has a fluidic connection to the gas outlet opening 8 of the nozzle stock 3.

A front and/or rear inflow region to introduce the protective gas into the flow space 11 is provided on the front end 23 and/or on the rear end 24 of the nozzle stock insert 20 that is formed by a front 25 and/or rear gap 26.

In this particular exemplary embodiment, these gaps 25, 26 substantially extend vertically in relation to the length axis of the nozzle stock 3 or the nozzle stock insert 20.

The first embodiment of the torch neck according to FIG. 1 shows that an inflow region formed by the front gap 25 is merely specified on the front end 23 of the nozzle stock insert 20. In order to form the front gap 25 and the front inflow region, the front end 23 of the nozzle stock insert 20 is arranged at a distance to a front dead stop or an edge 28 of the nozzle stock 3. In this embodiment, the rear end 24 directly contacts, e.g., directly abuts, an inner tube 18 of the torch neck 10, without forming a gap. FIG. 2 provides a detailed view, and FIGS. 6 and 7 provide an exploded representation, of this embodiment.

The gas flows from a gas reservoir through the inner tube 18 toward the nozzle stock insert 20.

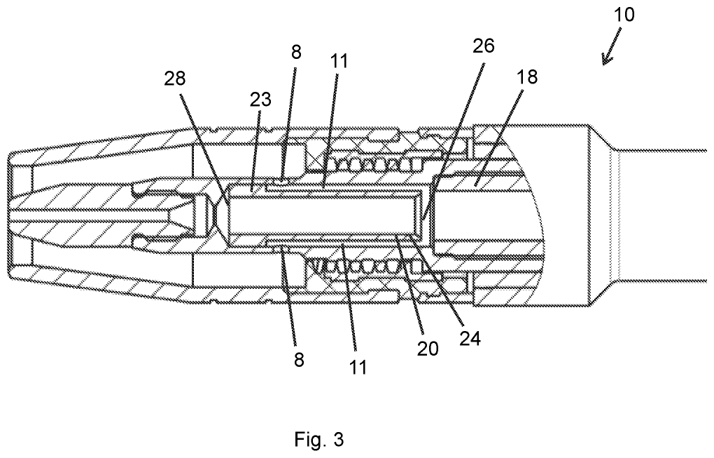

FIG. 3 shows a second embodiment of the torch neck, wherein an inflow region formed by the rear gap 26 is specified only on the rear end 24 of the nozzle stock insert 20. In this particular embodiment, the rear gap 26 is formed in that the rear end 24 of the nozzle stock insert 20 is arranged at a distance to the front end of an inner tube 18 of the torch neck 10, as shown in FIG. 3. In this case, the front end 23 directly abuts the dead stop 28 of the nozzle stock 3 of the torch neck 10, without forming a gap.

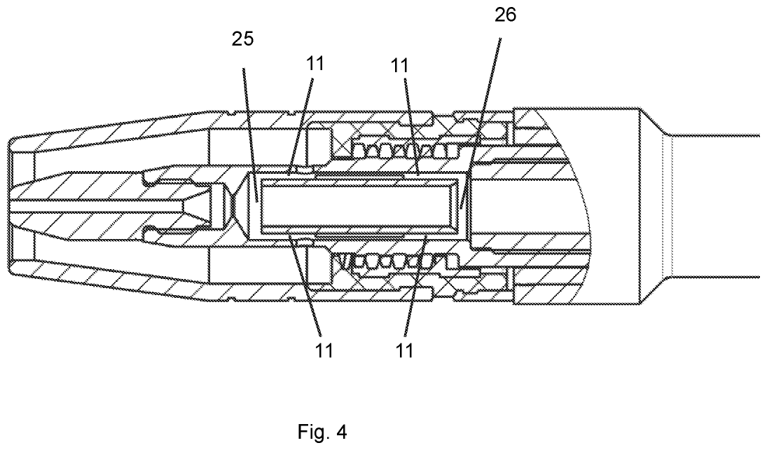

FIG. 4 shows a third embodiment, on which respectively one gap 25, 26 is specified on the front end 23 and also on the rear end 24 of the nozzle stock insert 20, the gap 25, 26 respectively forming an inflow region for the protective gas into the flow space 11.

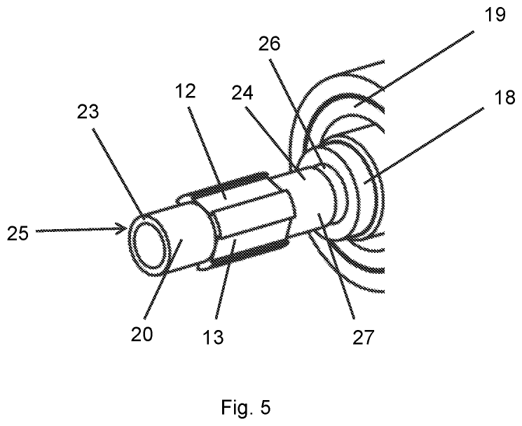

The perspective representation in FIG. 5 shows an exemplary embodiment of the torch neck 10, wherein the flow space 11 is formed by several linear gaps 12 between the inner wall 9 of the nozzle stock 3 and the outer wall 22 of the nozzle stock insert 20 that extend along the outer surface 27 of the nozzle stock insert 20 in length direction of the insert 20.

In this particular embodiment, the linear gap 12 is formed by the grooves 13 substantially extending in length direction of the nozzle stock insert 20 on the outer wall 22 of the nozzle stock insert 20, the grooves 13 preferably being arranged approximately equidistantly in relation to one another along the circumference.

The protective gas in this case flows from the inner tube 18 through the grooves 13 toward the gas outlet opening 8 of the nozzle stock 3, and then continues to the gas outlet 2 of the gas nozzle 1.

According to an alternative embodiment, the flow space 11 can be substantially formed by a helical gap 14 that is formed by a thread 15, in particular a trapezoidal thread substantially extending in length direction on the outer wall 22 of the nozzle stock insert 20.

On the embodiment in FIG. 3, on which the inflow region is formed by the rear gap 26, this gap 26 is located upstream of the gas outlet opening 8 of the nozzle stock 3, as seen in flow direction of the protective gas. A linear gas flow is generated in this manner, since the protective gas flows from the inner tube 18 of the torch neck 10 into the inflow region formed by the rear gap 26, and is introduced into the flow space 11 and then guided through the gas outlet opening 8 of the nozzle stock 3 and then exits from gas outlet 2 of the gas nozzle 1.

Alternatively, it is conceivable that the front gap 25 is located downstream—as seen in flow direction—of the gas outlet opening 8 of the nozzle stock 3, as is shown in FIGS. 1 and 2. A reverse flow of the stream of protective gas is formed in this manner, since the gas flow is introduced through the inner tube 18 into the interior of the nozzle stock insert 20, then enters the inflow region formed by the front gap 25, and is then forwarded into the flow space 11 up to the gas outlet opening 8 of the nozzle stock 3, through which the gas flow is then guided up to the gas outlet 2 of the gas nozzle 1.

As shown in FIG. 1, the protective gas accordingly firstly flows in the interior of the nozzle stock insert 20 toward the front end of the torch neck 10 or the gas nozzle 1. The protective gas is then introduced through the front inflow region transversally in relation to the length axis 6 of the nozzle stock 3 into the flow space 11, through which the protective gas then flows opposite to the flow direction in the interior of the nozzle stock insert 20, that is to say toward the rear, until the gas is guided through the gas outlet opening 8 of the nozzle stock 3 back to the front toward the gas outlet 2 of the gas nozzle 1, thus generating the reverse flow.

On this embodiment, the protective gas flows in the interior of the nozzle stock insert 20. By contrast, is likewise conceivable that the stream of protective gas alternatively or additionally also flows on the outer surface 27 of the nozzle stock insert 20.

According to an embodiment, it can be specified that the opposing first 23 and second ends 24 extend along the axis 5 of the nozzle stock insert 20 with a length between the end 23, 24, and that the diameter of the nozzle stock insert 20 varies along its axis. It is in particular conceivable that the nozzle stock insert 20 on its front end 23 facing the gas outlet 2 of the gas nozzle 1 has a smaller cross-section compared to the rear end 24 of the nozzle stock insert 20 facing away from the gas outlet 2 in order to form an annular channel 16 of the flow space 11, in particular, the flow direction of the stream of protective gas in the annular channel 16 can be changed at least once, such that the flow duration or the flow path of the stream of protective gas is lengthened within the gas nozzle 1.

The nozzle stock insert 20, the flow contact nozzle 17, and the nozzle stock 3 can be constructed of a conductive material, in particular, they can be produced from copper or copper alloys. The nozzle stock insert 20 can contact the flow contact nozzle 17. But it is also conceivable that the nozzle stock insert 20 and the flow contact nozzle 17 can contact one another after assembly in the torch neck 10, e.g., directly abut one another. The nozzle stock insert 20 is located in the nozzle stock 3, and the nozzle stock is fastened on the torch neck 10.

The torch neck 10 can be arranged in a torch, which in turn is part of a welding apparatus.

### LIST OF REFERENCE NUMERALS

1 Gas Nozzle
2 Gas Outlet
3 Nozzle Stock
4 First Nozzle Stock End
5 Second Nozzle Stock End
6 Nozzle Stock Length Axis
7 Nozzle Stock Cavity
8 Nozzle Stock Gas Outlet Opening
9 Nozzle Stock Inner Wall
10 Torch Neck
11 Flow Space
12 Linear Gap
13 Grooves
14 Helical Gap
15 Thread
16 Annular Channel
17 Flow Contact Nozzle
18 Inner Tube
19 Outer Tube
20 Nozzle Stock Insert
21 Inner Nozzle Stock Passageway
22 Nozzle Stock Insert Outer Wall
23 Nozzle Stock Insert Front End
24 Nozzle Stock Insert Rear End
25 Front Gap
26 Rear Gap
27 Nozzle Stock Insert Outer Surface
28 Front Dead Stop or Edge of the Nozzle Stock

1. A torch neck (10) for a welding device for thermally joining at least one workpiece, comprising:
a nozzle stock (3), which has an internal cavity (7) with an inner wall (9) and at least one gas-outlet opening (8), which gas-outlet opening (8) is in fluidic connection with a gas outlet (2) of a gas nozzle (1) for the outflow of a stream of protective gas,
a nozzle-stock insert (20) , arranged in the internal cavity (7) of the nozzle stock (3), said nozzle-stock insert (20) having a front end (23) and a rear end (24) and an outer wall (22), wherein the outer wall (22) of the nozzle-stock insert (20) is at a distance from the inner wall (9) of the nozzle stock (3), at least in some regions, to form a flow space (11) for the stream of protective gas, and the flow space (11) is in fluidic connection with the gas-outlet opening (8) of the nozzle stock (3), and
a front and/or rear inflow region, which is formed by a front and/or rear gap (25, 26) provided at the front end (23) and/or at the rear end (24) of the nozzle-stock insert (20) through which protective gas is introduced into the flow space (11).

2. The torch neck (10) according to claim 1, wherein the front end (23) of the nozzle stock insert (20) is spaced at a distance to a front dead stop (28) of the nozzle stock (3) to form the front inflow region formed by the front gap (25).

3. The torch neck (10) according to claim 1, wherein the rear end (24) of the nozzle stock insert (20) is spaced at a distance to the front end of an inner tube (18) of the torch neck (10) to form the rear inflow region formed by the rear gap (26).

4. The torch neck (10) according to claim 1, wherein the rear gap (26) is located upstream—as seen in flow direction of the protective gas—of the gas outlet opening (8) of the nozzle stock (3) to form a linear gas flow.

5. The torch neck (10) according to claim 1, wherein the front gap (25) is located downstream—as seen in flow direction—of the gas outlet opening (8) of the nozzle stock (3) to form a reverse flow of the stream of protective gas.

6. The torch neck (10) according to claim 1, wherein the nozzle stock insert (20) has an outer surface (27) and the protective gas flows on the outer surface (27) of the nozzle stock insert (20) and/or in the interior of the nozzle stock insert (20).

7. The torch neck (10) according to claim 1, wherein the nozzle stock insert (20) is connected to the nozzle stock (3), and is in particular pressed in.

8. The torch neck (10) according to claim 1, wherein the flow space (11) is substantially at least one linear gap (12) between the inner wall (9) of the nozzle stock (3) and an outer wall (22) of the nozzle stock insert (20).

9. The torch neck (10) according to claim 8, wherein the linear gap (12) is formed by grooves (13) substantially extending in length direction of the nozzle stock insert (20) on the outer wall (22) of the nozzle stock insert (20).

10. The torch neck (10) according to claim 1, wherein the flow space (11) is substantially formed by a helical gap (14) that is formed by a thread (15) that substantially extends in length direction on an outer wall (22) of the nozzle stock insert (20).

11. The torch neck (10) according to claim 1, wherein the opposing first (23) and second ends (24) of the nozzle stock insert (20) extend along the axis of the nozzle stock insert (20) with a length between the ends (23, 24), and in that the diameter of the nozzle stock insert (20) varies along its length.

12. The torch neck (10) according to claim 1, wherein the nozzle stock insert (20) on its front end (23) facing the gas outlet (2) of the gas nozzle (1) has a smaller cross-section compared to the rear end (24) of the nozzle stock insert (20) facing away from the gas outlet (2) in order to form an annular channel (16) of the flow space (11).

13. The torch neck (10) according to claim 12, wherein the flow direction of the stream of protective gas in the annular channel (16) is changed at least once, such that the flow duration or the flow path of the stream of protective gas is lengthened within the gas nozzle (1).

14. The torch neck (10) according to claim 1, wherein the nozzle stock insert (20) has an inner passageway (21) configured to receive and pass therethrough an electrode or a wire for generating an arc between the electrode or the wire and the workpiece.

15. The torch neck (10) according to claim 1, wherein the gas flow flows from an inner tube (18) into the nozzle stock insert (20).

16. The torch neck (10) according to claim 1, further comprising a flow contact nozzle (17) positioned in the internal cavity (7) of the nozzle stock (3) such that the flow contact nozzle (17) extends into the internal cavity (7) of the nozzle stock (3).

17. The torch neck (10) according to claim 1, wherein the nozzle stock insert (20), the flow contact nozzle (17), and the nozzle stock (3) are constructed of a conductive material, and the nozzle stock insert (20) contacts the flow contact nozzle (17).

18. A torch having a torch neck (10) according to claim 1 and further comprising either an electrode, arranged in the torch neck (10), or a wire for producing an arc between the electrode or the wire and a workpiece.

19. The torch according to claim 18, wherein the nozzle stock insert (20) is arranged axially in a cavity (7) of the nozzle stock (3) between the torch neck (10) and the flow contact nozzle (17).

20. A welding apparatus having a torch according to claim 19.
